(19) United States
(12) Patent Application Publication
(10) Pub. No.: US 2006/0138150 A1
(43) Pub. Date: Jun. 29, 2006

(54) Pressurised container

(76) Inventors: Dirk Buechler, Serrahn (DE); Gerhard Buttkewitz, Kritzmow (DE); Georg Harzfeld, Roevershagen (DE)

Correspondence Address: JORDAN AND HAMBURG LLP, 122 EAST 42ND STREET, SUITE 4000, NEW YORK, NY, 10168, US

(21) Appl. No.: 10/545,329

(22) PCT Filed: Feb. 7, 2004
(86) PCT No.: PCT/EP04/01136

§ 371 Date: Nov. 3, 2005

(30) Foreign Application Priority Data
Feb. 11, 2003 (DE) 103 05 397.2

(51) Int. Cl. F17C 1/00

(52) U.S. Cl. 220/581

(57) ABSTRACT

The invention can be used for the pressurized storage of gases. The aim of the invention is to provide a pressurized container consisting of fibre-reinforced plastic with flat or practically flat lids. To achieve this, wound axially aligned reinforcement structures run through the interior of the body and absorb the major part of the required forces on their plane of alignment. The invention is characterized in that fibre strands are distributed uniformly over the cross-sectional surface of the cylindrical pressurized container, are aligned axially and fixed to flat or practically flat lids. In one advantageous embodiment of the invention, a container is formed by the spiral winding of an essentially unidirectional fibre-layer, which is thicker at its edges. Reinforcement layers, which are arranged in a circumferential direction and exert a radial action, cover the reinforcement strands or the spirally wound unidirectional fibre-layer, said layers forming the casing of the pressurized container.

The invention refers to a pressurized container of fibre-reinforced plastic for the storage of gases.

### BACKGROUND OF THE INVENTION

The prior art is characterized by pressurized container which contain an internal liner of metal or plastic. The fibre-reinforced plastic is applied to the internal liner by means of a winding method (concerning this see DE-OS 199 52 611). When applying this method the axial strength is obtained by longitudinal windings and the circumferential windings is obtained separately by circumferential windings.

As an essential element of the vessels the internal liner serves as a supporting frame for the application of the fibre-reinforced plastic as well as a barrier to permeation of gases. The strength of the pressurized container is achieved by application of fibre-reinforced plastic.

The disadvantage of the design described above is that the internal liner increases the weight of the component. Moreover, an unfavorable material distribution arises in the areas of the domes, because a non-strength-causing accumulation of material occurs in the area of the poles of the domes by the winding process. A problem which stands in the way of using the biggest possible volume of the known vessels refers to the fact that the front sides of the pressurized container are always shaped as convex domes. Due to the shape of the domes an unfavorable use of volume is given.

A modification of the domes by a so-called isotensoid shape and a modification of the distribution of fibers and angles can only partly defuse this problem.

Due to the arrangement of fibre cords in the area of the periphery or jacket of the pressurized container and due to the winding process forces have to be absorbed from several directions.

### BRIEF SUMMARY OF THE INVENTION

The invention is based on the problem to develop a pressurized container which makes possible a substantial improvement in design of the pressurized container with little expenditure. For this purpose a pressurized container of fibre-reinforced plastic with plane or almost plane covers shall be developed by which the above-mentioned disadvantages will be reduced.

According to the invention this problem is solved in such a way that at least in one direction there are arranged axially aligned reinforcement structures going through the interior of the pressurized container and which are equally distributed in the interior and absorb the major part of the forces caused by the inside pressure.

The invention is characterized by the feature that fibre cords of fibre-reinforced composite materials (preferably carbon fibers and impregnated with a matrix of epoxy resin), which are arranged equally distributed over the cross-sectional area of the cylindrical pressurized container, are exactly axially aligned and are fixed to plane or largely plane covers.

It is intended by an advantageous further development that a vessel shall be created by the spiral winding-up of a largely unidirectional fibre layer which is thickened at the ends.

The fibre orientation of the layer on the area is across the winding direction. The thickened spots may also be oriented in a different direction or made of a different material.

Over the reinforcement cords or the spirally winded-up unidirectional fibre layer there will be applied circumferentially aligned, radially acting reinforcement layers which form the seal of the pressurized container. Another aspect of the invention is that an axial reinforcement is effected in more than one direction. Furthermore, it is intended to combine a combination of axial reinforcements going through the interior with reinforcements, which are integrated in the outer jacket.

It is intended by one design, for increasing the gas tightness of the pressurized container to wind up barrier layers between the outer layer of axial reinforcement and the circumferentially winded outer jacket, which are largely overlapping each other.

The use of the almost plane covers of the vessels was found to be surprising and provides a technical solution which makes it possible to translate into reality a number of advantages when designing the winded pressurized container.

For fixing the covers on both sides, an inside gas-open reinforcing pipe presents itself.

The covers which form the front sides of the pressurized container consist of suitable light metallic materials or of fibre-reinforced plastic. For integrating the reinforcement structures slots may be made at regular angles, but at different depths. At the same time the solution is made possible by this, to connect the fittings of the pressurized container in a gas-tight manner with the gas connections.

The invention is characterized by a number of advantages:

No internal liner is required.

The reinforcing materials are almost completely oriented to the direction of the forces appearing. From both features a clear improvement of the weight-specific storage capacity is resulting. The manufacture is simplified.

An integration into plants is possible in a more space-saving way due to a more favorable shaping design and thus an increase of the volumetric storage density is provided.

### BRIEF DESCRIPTION OF THE DRAWINGS

Accompanying the specification are figures which assist in illustrating the embodiments of the invention, in which:

FIG. 1 Pressurized container with fibre cords;

FIG. 2 Pressurized container with unidirectional layers; and

FIG. 3 Unidirectional layers.

### DETAILED DESCRIPTION OF THE INVENTION

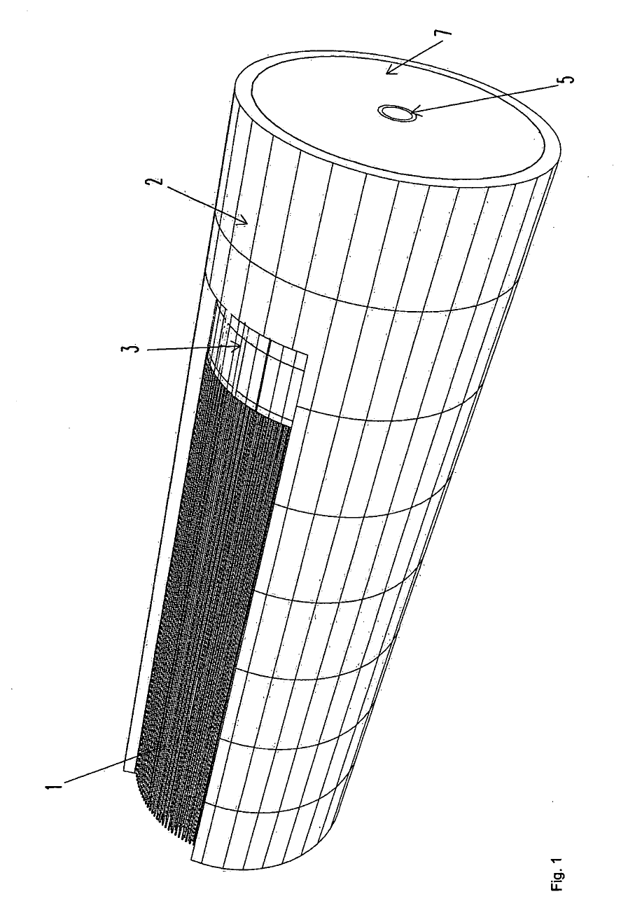

The pressurized container as shown by FIG. 1 is created by arrangement of axially through-going reinforcement structures 1, which consist of fibre cords of fibre-reinforced composite materials, preferably impregnated single threads of carbon fibers or other high-strength thread-shaped cords, inside a cylinder. They are largely equally distributed over the cross-sectional area and are anchored on plane covers 7. The covers 7 are also made from the cord material by means of a winding technology or are wrapped up by a different material. Preferably in the center of the covers, a metallic connection 5 for the fittings is embedded into the composite material.

In the outer bounds of the pressure space these reinforcement cords are arranged very closely, so that they can be covered with a barrier layer 3. Onto this layer then the radial reinforcements 2 are winded up, which result in the radial reinforcement and form the outer seal of the pressurized container.

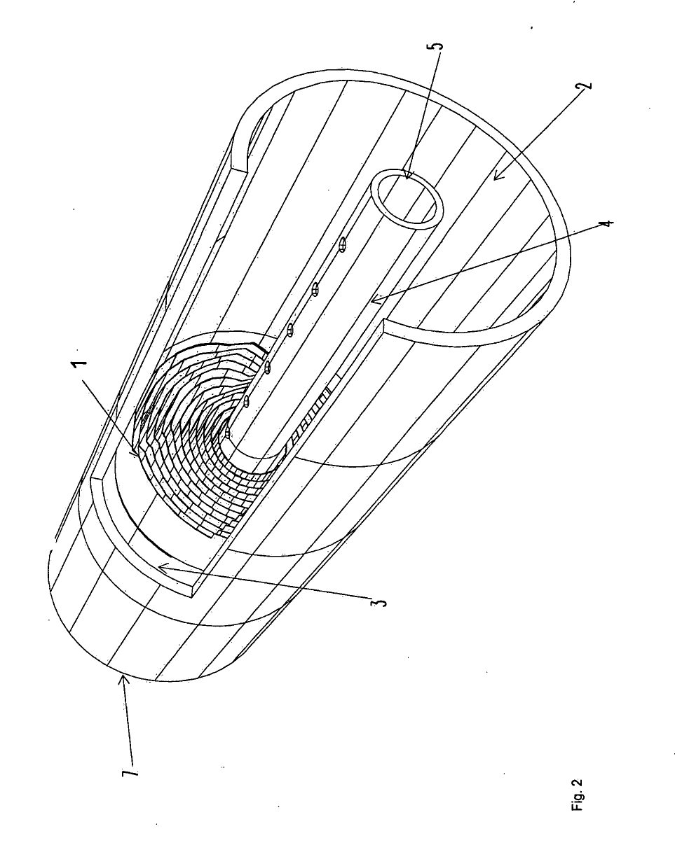

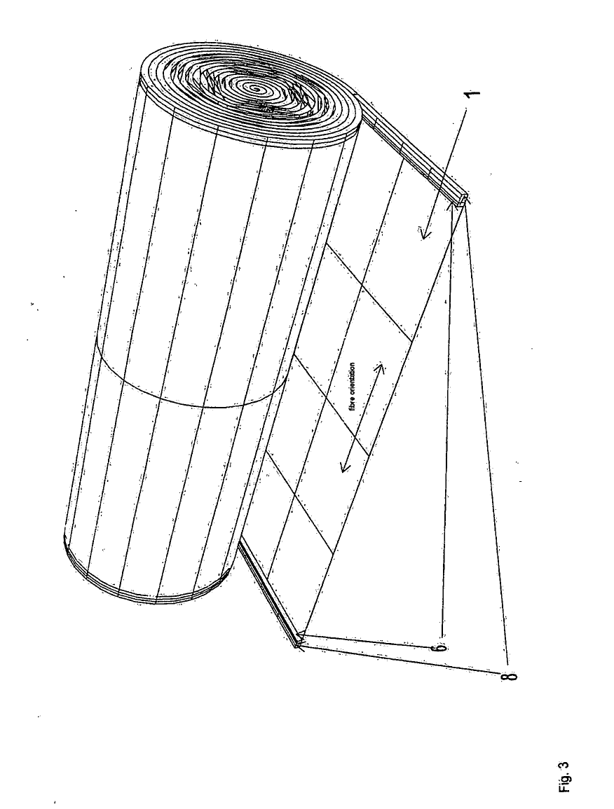

The pressurized container as shown by FIGS. 2 and 3 is created by winding up a semi-finished product consisting of a ground coat of unidirectional layers (coat-type layers of fibre-reinforced composite materials, preferably carbon fibers impregnated with a matrix of epoxy resin), with thickened spots 8 applied at the ends. These thickened spots are also preferably created by composite material and may additionally contain barrier layers 6.

The semi-finished product is usually pre-impregnated with a matrix system. Winding up may be done on a metallic reinforcing pipe 4 which at the same time carries the fittings. For this purpose the pipe must have 4 openings for flowing through of the storage medium.

When winding up the semi-finished product is oriented in such a way that the direction of fibers in the ground coat corresponds with the axial direction of the pressure body.

The thickened spots 8 on the edge area just form the axial border of the pressure body.

Onto the spiral-shaped core created a barrier layer 3 acting in radial direction can be applied.

On this layer then a radially acting reinforcing layer 2 oriented to circumferential direction will be lying.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1-10. (canceled)

11. A pressurized cylindrical container comprising:
axially reinforcing structures for absorbing forces from internal pressure in said pressurized container, said axially reinforcing structures disposed interior of said pressurized container;
said axially reinforcing structures consist of fiber cords, said fiber cords equally distributed over a cross-sectional area of said pressurized container;
said fiber cords being exactly axially aligned, mutually parallel and enclosed by a radial reinforcement layer; and
said radial reinforcement layer being circumferentially aligned.

12. The pressurized container of claim 11 wherein:
said axial reinforcing structures consist of spiral-shaped winded up unidirectional layers of a composite material;
said axial reinforcing structures have thickened spots at an end of said layers of composite material;
said axial reinforcing structures forming covers; and
said axial reinforcing structures being enclosed by said radial reinforcement layer.

13. The pressurized container of claim 12 wherein barrier layers disposed between an outer layer of said axial reinforcing structures and said radial reinforcement layer, said barrier layers reducing permeation of gases.

14. The pressurized container of claim 12 further comprising a wound up cord-shaped overlapping barrier layer.

15. The pressurized container of claim 14 further comprising:
covers including slots, said slots being successively disposed at a predetermined constant angle, said successive slots having differing depths; and
said axial reinforcing structures being fixed in said slots.

16. The pressurized container of claim 15 wherein fittings are connected gas-tight with said covers.
